(19) United States
(12) Patent Application Publication
(10) Pub. No.: US 2025/0037108 A1
(43) Pub. Date: Jan. 30, 2025

(54) COMPUTER-BASED SYSTEM FOR PROVIDING TOUCHLESS TRANSACTIONS AT AUTOMATED TELLER MACHINES

(71) Applicant: Wells Fargo Bank, N.A., San Francisco, CA (US)

(72) Inventors: Michael Thomas, San Francisco, CA (US); Marilyn Paige, Playa Vista, CA (US); Xin Wan, San Francisco, CA (US); Christian Mande, Charlotte, NC (US)

(21) Appl. No.: 17/473,761

(22) Filed: Sep. 13, 2021

(51) Int. Cl. G06Q 20/34; G06F 16/955; G06Q 20/36; G06Q 20/38

(52) U.S. Cl. CPC G06Q 20/352; G06F 16/955; G06Q 20/3674; G06Q 20/3825; G06Q 2220/00

(57) ABSTRACT

Techniques are described for providing touchless ATM transactions based on receipt of a pre-staged transaction initiated by an authenticated user via an online banking system of a bank and subsequent receipt of a cryptogram of the user's payment card at an ATM. A server device receives transaction data for the pre-staged transaction from a user computing device via a user interface of an application associated with the online banking system. The server device associates the pre-staged transaction with a bank account including one or more payment cards of the user. The server device later receives a cryptogram of a payment card from an ATM and, based on identification information included in the cryptogram, determines that the payment card at the ATM is one of the payment cards of the bank account associated with the pre-staged transaction. In response, the server device authorizes performance of the pre-staged transaction at the ATM.

### TECHNICAL FIELD

The disclosure relates to computer-based systems for processing transactions via automated teller machines.

### BACKGROUND

Automated teller machines (ATMs) provide account holders with a convenient way to perform account access functions. In some examples, a financial institution may provide a number of ATMs at both its retail banking locations and at other remote locations that may be more convenient for account holders such as, for example, office buildings, grocery stores, college campuses, or shopping centers. Additionally, some financial institutions may allow its account holders to perform account access functions using ATMs serviced by other financial institutions, providing an even wider range of locations for the account holder to perform account access functions. In addition to providing more convenient locations, ATMs may also provide account holders with more convenient hours of operation by being available for use during times when a financial institution's retail banking locations are closed, otherwise unavailable, or busy.

### SUMMARY

The disclosure describes techniques for providing touchless automated teller machine (ATM) transactions based on receipt of a pre-staged transaction initiated by an authenticated user via an online banking system of a bank and subsequent receipt of a cryptogram of the user's payment card at an ATM. In some examples, at least one server device associated with the online banking system receives transaction data for the pre-staged transaction from a user computing device, e.g., a user's desktop or laptop computer, tablet computer, or mobile device, via a user interface of an application associated with the online banking system. In response, the server device associates the pre-staged transaction with a bank account including one or more payment cards of the user. A short time later, the server device may receive a cryptogram of a payment card from an ATM, where the payment card may be a physical card or a virtual card in a digital wallet application running on a user mobile device (which could be the same or a different device than the user computing device used to initiate the pre-staged transaction). Based on identification information included in the cryptogram, the server device determines whether the payment card at the ATM is one of the one or more payment cards of the bank account associated with the pre-staged transaction. In response to determining that the payment card at the ATM is associated with the pre-staged transaction, the server device authorizes performance of the pre-staged transaction at the ATM.

In some examples, associating the pre-staged transaction with the bank account of the user includes associating the pre-staged transaction with the one or more payment cards of the bank account of the user for a predetermined period of time, e.g., 30 minutes or 1 hour. The server device may determine that the payment card at the ATM is associated with the pre-staged transaction in response to receipt of the cryptogram of the payment card from the ATM during the predetermined period of time for the pre-staged transaction. The cryptogram of the payment card is received by the ATM when the payment card is proximate to the ATM. For example, a card reader of the ATM may emit a short-range signal, e.g., a near-field communication interrogation signal, requesting information from any payment cards brought near the card reader such that the card reader may receive the cryptogram from the payment card in response to the user waving or tapping the physical or virtual payment card near the card reader. In other examples, the card reader of the ATM may receive the cryptogram from the payment card in response to the user inserting or dipping the physical payment card into a slot of the card reader.

The touchless ATM transaction techniques described herein may provide one or more benefits or advantages. The touchless ATM transaction may enable performance of transactions via an ATM without a user having to physically touch any component of the ATM. In this way, personal and public safety may be improved, the user may feel more comfortable or safer performing an ATM-based transaction, and the ATM-based transaction may be less time consuming, frustrating, or inconvenient for the user. The touchless ATM transaction may also be more secure than conventional ATM-based transactions. The touchless ATM transaction described herein uses validated user login credentials to an online banking system for pre-staging the transaction plus a payment card cryptogram received from an ATM to authenticate the user and authorize the transaction at the ATM, compared to a conventional ATM transaction that uses a payment card cryptogram plus a user's static PIN both received from the ATM.

In one example, this disclosure is directed to a method comprising receiving, by at least one server device associated with an online banking system, transaction data for a pre-staged transaction from a user computing device of a user via a user interface of an online banking application for the online banking system; associating, by the at least one server device, the pre-staged transaction with a bank account including one or more payment cards of the user; receiving, by the at least one server device, a cryptogram of a payment card from an ATM, wherein the ATM receives the cryptogram of the payment card when the payment card is proximate to the ATM; determining, by the at least one server device and based on identification information included in the cryptogram of the payment card, that the payment card at the ATM is one of the one or more payment cards of the bank account associated with the pre-staged transaction; and authorizing, by the at least one server device, performance of the pre-staged transaction at the ATM.

In another example, this disclosure is direct to a network system including at least one server device associated with an online banking system, the at least one server device comprising a memory and one or more programmable processors in communication with the memory. The one or more programmable processors of the at least one service device are configured to receive transaction data for a pre-staged transaction from a user computing device of a user via a user interface of an online banking application for the online banking system; associate the pre-staged transaction with a bank account including one or more payment cards of the user; receive a cryptogram of a payment card from an ATM, wherein the ATM receives the cryptogram of the payment card when the payment card is proximate to the ATM; determine, based on identification information included in the cryptogram of the payment card, that the payment card at the ATM is one of the one or more payment cards of the bank account associated with the pre-staged transaction; and authorize performance of the pre-staged transaction at the ATM.

In a further example, this disclosure is direct to a computer-readable medium storing instructions that, when executed, cause one or more programmable processors of at least one server device associated with an online banking system to receive transaction data for a pre-staged transaction from a user computing device of a user via a user interface of an online banking application for the online banking system; associate the pre-staged transaction with a bank account including one or more payment cards of the user; receive a cryptogram of a payment card from an ATM, wherein the ATM receives the cryptogram of the payment card when the payment card is proximate to the ATM; determine, based on identification information included in the cryptogram of the payment card, that the payment card at the ATM is the one of the one or more payment cards of the bank account associated with the pre-staged transaction; and authorize performance of the pre-staged transaction at the ATM.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example network system that includes an online banking system and an ATM system configured to provide touchless ATM transactions to users, in accordance with the techniques of this disclosure.

FIG. 2 is a block diagram illustrating an example bank server configured to facilitate touchless ATM transactions, in accordance with the techniques of this disclosure.

FIG. 3 is a block diagram illustrating an example ATM server configured to facilitate touchless ATM transactions, in accordance with the techniques of this disclosure.

FIG. 4 is a block diagram illustrating an example user computing device configured to initiate touchless ATM transactions, in accordance with the techniques of this disclosure.

FIG. 5 is a block diagram illustrating an example ATM, in accordance with aspects of the disclosure.

FIG. 6 is a flow chart illustrating an example operation of a server device to facilitate a touchless ATM transaction for a user, in accordance with aspects of the disclosure.

### DETAILED DESCRIPTION

The disclosure describes techniques for providing touchless automatic teller machine (ATM) transactions that are pre-staged via an online banking system using a user computing device. A user may log into the online banking system executing on at least one server device of a bank network via an application executing on the user computing device. Upon authentication by the online banking system, the user may input transaction data via the application executing on the user computing device to request a pre-staged transaction with a bank account of the user via the online banking system executing on the server device. Upon receiving the transaction data for the pre-staged transaction, the online banking system executing on the server device may associate the pre-staged transaction with the bank account including one or more payment cards of the user for a predetermined period of time, e.g., 30 minutes or 1 hour. For example, the server device may associate the pre-staged transaction with a physical card or a virtual card in a digital wallet on the user computing device for the predetermined period of time.

By presenting the physical card or the virtual card at an ATM within the predetermined period of time, the user is able to complete the pre-staged transaction at the ATM in a touchless manner. For example, the physical card or the virtual card may be waved, tapped, or otherwise brought within a certain proximity of a card reader of the ATM. Upon associating the pre-staged transaction with the one or more payment cards of the bank account of the user and receiving an authorization request cryptogram of the one or more payment cards from the ATM, the server device is configured to verify the user, access the bank account of the user, retrieve the pre-staged transaction data, and authorize the ATM to perform the pre-staged transaction without the user having to physically touch any component of the ATM. In this way, the touchless ATM transaction techniques described herein may advantageously promote personal and public safety and allow the user may feel more comfortable and/or safer performing a transaction via an ATM through the use of the user's own user computing device to request the pre-staged transaction. Moreover, the touchless ATM transaction may be less time consuming, frustrating, and/or inconvenient for the user. In addition, the touchless ATM transaction may also be more secure based on the use of mobile banking user login credentials and a payment card cryptogram to authenticate the user and authorize the transaction at the ATM, as opposed to more traditional ATM transaction security of a payment card cryptogram and a static personal identification number (PIN).

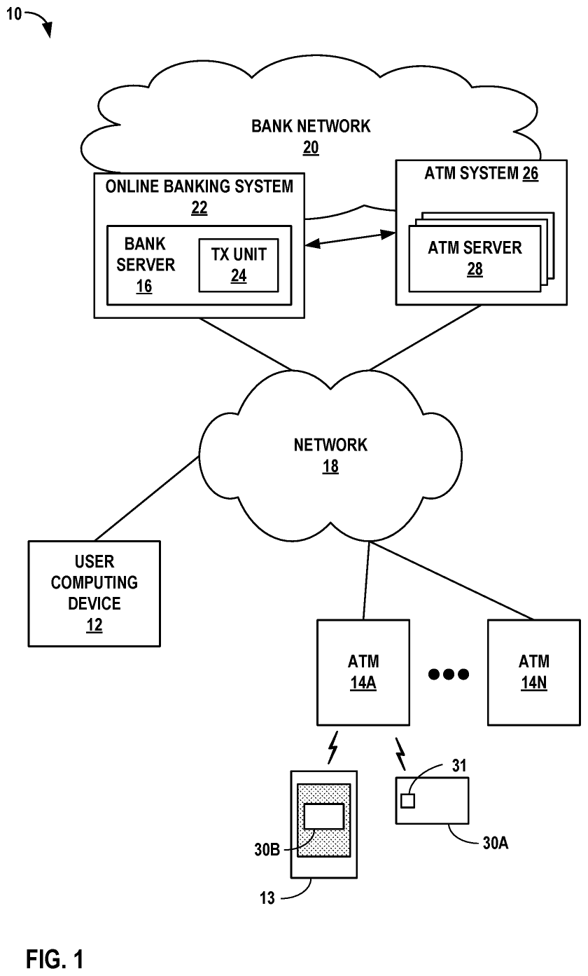

FIG. 1 is a block diagram illustrating an example network system 10 that includes an online banking system 22 and an ATM system 26 configured to provide touchless ATM transactions to users, in accordance with the techniques of this disclosure. As shown in the in example of FIG. 1, online banking system 22 and ATM system 26 may be included within a bank network 20 affiliated with a particular financial institution. Online banking system 22 may operate or be supported by one of more server devices, including a bank server 16, which may be owned and/or operated by the financial institution as part of bank network 20. ATM system 26 may include a plurality of ATM servers 28 in communication with a plurality of ATMs 14A-14N (collectively “ATMs 14”), which may be owned and/or operated by the financial institution and distributed across a wide geographic area.

Online banking system 22 provides authenticated users with secure access to bank accounts held by the financial institution via an online banking application running on the users' computing devices, e.g., user computing device 12. Online banking system 22 may authenticate the users based on user login credentials, such as a user name and password or biometric information, received via a login user interface of the online banking application running on the users' computing devices. Similarly, ATM system 26 provides authenticated users with secure access to bank accounts held by the financial institution via an ATM, e.g., any of ATMs 14. For traditional transactions, ATM system 26 may authenticate the users based on some combination of a payment card cryptogram, a static personal identification number (PIN), a one-time passcode (OTP), or an access code received via a user interface of the ATM.

In either scenario, after authentication, online banking system 22 or ATM system 26 enables the users to access information related to their bank accounts to perform account access functions requested by the users via user computing device 12 or ATM 14, respectively. For example, bank network 20 may perform the requested financial transactions including one or more of fund transfers, account balance checks, check cashing, or, in the case of ATM-requested transactions, fund deposits and withdrawal transactions.

In the example of FIG. 1, user computing device 12 is in communication with online banking system 22 via network 18, and each of ATMs 14 is in communication with online banking system 22 and/or ATM system 26 via network 18. In some examples, network 18 may be a private network or a public network, such as the Internet. Although illustrated as a single entity, network 18 may include a combination of two or more public and/or private networks. Network 18 may include one or more of a wide area network (WAN) (e.g., the Internet), a local area network (LAN), a virtual private network (VPN), or another wired or wireless communication network. In some examples, network 18 may be a service provider network coupled to one or more networks administered by other providers, and may thus form part of a large-scale public network infrastructure, e.g., the Internet.

The financial institution affiliated with bank network 20 may be a traditional bank or credit union with the capability to maintain user accounts, or may be a third-party for storing information for one or more traditional banks or credit unions but may not necessarily maintain any user accounts. Bank network 20 may comprise a centralized or distributed system of computing devices, such as desktop computers, laptops, workstations, wireless devices, cloud-based compute nodes, network-ready appliances, file servers, print servers, or other devices, configured to execute and/or support all or a portion of online banking system 22 and/or ATM system 26. For example, bank network 20 may include or have access to a plurality of databases, data centers, public or private cloud systems, and other storage facilities in which checking, savings, and/or investment accounts for users are stored.

As illustrated in the example of FIG. 1, bank server 16 is an example computing device used to support online banking system 22. The functionality of bank server 16 may be implemented in hardware or in a combination of software and hardware, where requisite hardware may be provided to store and execute software instructions. While shown as a single computing device in the example of FIG. 1 for purposes of illustration, in some examples, bank server 16 may include a distributed network of computing devices including one or more workstations, servers, and/or other computing devices within bank network 20.

ATM server 28 is an example computing device used to support ATM system 28. The functionality of ATM server 28 may be implemented in hardware or in a combination of software and hardware, where requisite hardware may be provided to store and execute software instructions. In the example of FIG. 1, ATM system 26 includes a plurality of ATM servers 28. Each of ATM servers 28 may be in communication within one or more of ATMs 14 depending on the geographic location of the ATMs and the processing power of the respective ATM server 28.

User computing device 12 may include any of a wide range of user devices, including mobile computing devices, laptop or desktop computers, tablet computers, so-called “smart” phones, “smart” pads, or other personal digital appliances equipped for wired or wireless communication. User computing device 12 may include one or more output interfaces and one or more input interfaces. For example, user computing device 12 may include one or more input interfaces including at least one of a keypad, a touch screen, or a microphone, enabling the user to input information or selections using user computing device 12. Additionally, or alternatively, user computing device 12 may include one or more output interfaces including at least one of a display, a speaker, or an audio output device, enabling user computing device 12 to provide instructions to the user.

ATM 14 may be a device used to perform a variety of account access functions, such as, for example, financial transactions including one or more of withdrawal transactions, fund deposits, fund transfers, check cashing, or account balance checks. ATM 14 may include a display for displaying information. Additionally, ATM 14 may include a physical keyboard, a touch display, a scanner, one or more card readers, and/or other input devices for receiving inputs. ATM 14 may also include components for vending or accepting cash and/or checks for various transactions including, for example, conventional deposits or withdrawals, exchange of local currency for foreign currency or vice versa, and/or withdrawal of foreign currency. ATM 14 may include a printer component for printing documents for various transactions including, for example, receipts for deposits, receipts for withdrawals, receipts for purchases, or the like. ATM 14 may include a component to dispense envelopes. ATM 14 may also include a component to dispense cash and/or a component to dispense cash within an envelope. The components of ATM 14 described herein may be separate components, each dedicated to a separate function, or may be combined in any suitable number of components to perform the functions described herein. A single component may include different subcomponents used for performing different tasks or may use the same subcomponents for each task according to particular needs.

Traditionally, in order to access a bank account or perform a transaction via an ATM, a user needs to press keys on a physical keyboard or select options on a touch-sensitive display screen with one or more fingers. The action of the user pressing keys on the physical keyboard of the ATM or selecting options on the display screen of the ATM with one or more fingers exposes the user to unsanitary dirt and bacteria on the physical keyboard and/or the display screen from previous users of the ATM. In addition, the public nature of ATMs may make such financial transactions less secure due to the need for the user to enter a PIN or access code via the physical keyboard or the touch-sensitive display screen in a manner that may be visible to others.

The disclosure describes techniques for providing touchless ATM transactions that are pre-staged via online banking system 22 and completed at one of ATMs 14. For example, bank server 16 of online banking system 22 may receive user login credentials for a bank account of a user via a login user interface of an online banking application running on user computing device 12. Once the user is authenticated and provided with access to the bank account, touchless transaction (TX) unit 24 of bank server 16 receives transaction data for a pre-staged transaction from user computing device 12 via a user interface of the online banking application. In response, touchless transaction unit 24 associates the pre-staged transaction with the bank account including one or more payment cards of the user. For example, touchless transaction unit 24 may associate the pre-staged transaction with a physical card 30A or a virtual card 30B in a digital wallet on a user mobile device 13 for a predetermined amount of time, e.g., 30 minutes to 1 hour. In examples where user computing device 12 comprises a mobile computing device, user mobile device 13 may be the same device as user computing device 12. In examples where user computing device 12 is a non-mobile device of the user, e.g., a laptop or desktop computer, user mobile device 13 may comprise any mobile computing device of the same user including a so-called “smart” phone, “smart” pad, or other personal digital appliance equipped for wireless communication.

At a later time, ATM server 28 of ATM system 26 receives a cryptogram of a payment card from one of ATMs 14, e.g., ATM 14A. As illustrated in FIG. 1, the payment card may be physical card 30A or virtual card 30B in a digital wallet application running on user mobile device 13. ATM 14A may receive the cryptogram of the payment card 30A, 30B when the payment card 30A, 30B is proximate to ATM 14A. For example, a card reader of ATM 14A may emit a short-range signal, e.g., a near-field communication interrogation signal, requesting information from any payment cards brought near the card reader such that the card reader may receive the cryptogram from the payment card 30A, 30B in response to the user waving or tapping the payment card 30A, 30B near the card reader. In other examples, the card reader of ATM 14A may receive the cryptogram from the physical payment card 30A in response to the user inserting or dipping a portion of the physical payment card 30A that includes an integrated circuit (IC) chip 31 into a slot of the card reader. The card reader of ATM 14A may receive the cryptogram of the payment card 30A, 30B without the user having to physical touch any component of ATM 14A.

ATM 14A communicates the received cryptogram of the payment card 30A, 30B to ATM server 28. In some example, the received cryptogram may be time stamped with an exact time at which ATM 14A received the cryptogram. Based on identification information included in the cryptogram, ATM server 28 and/or touchless transaction unit 24 of bank server 16 determines whether the payment card 30A, 30B at ATM 14A is one of the one or more payment cards of the bank account associated with the pre-staged transaction. The identification information included in the cryptogram of the payment card 30A, 30B may include card data (e.g., card number, user name, or other user or account identification data stored on payment card 30A, 30B) and terminal data (e.g., location or identification number of ATM 14A).

In some cases, ATM server 28 and/or touchless transaction unit 24 of bank server 16 may only determine that the payment card 30A, 30B is associated with the pre-staged transaction based on the time stamp of the cryptogram received from ATM 14A falling within the predetermined period of time for the pre-staged transaction. In response to determining that the payment card 30A, 30B at ATM 14A is associated with the pre-staged transaction, ATM server 28 and/or touchless transaction unit 24 of bank server 16 authorizes performance of the pre-staged transaction at ATM 14A. In this way, ATM 14A and bank server 16 and/or ATM server 28 may enable request and performance of financial transactions for a user without the user having to physical touch any component of ATM 14A.

In examples where the pre-staged transaction at least in part comprises a cash withdrawal, ATM server 28 and/or bank server 16 may withdraw an amount of funds for the cash withdrawal from the bank account of the user, and send instructions for ATM 14A to dispense the amount of funds to the user via a cash dispenser at ATM 14A. The cash dispenser may be configured such that the user need only touch the cash or an envelope to remove the cash from the cash dispenser while not physically touching any component of ATM 14A.

In one specific example where the pre-staged transaction comprises a check cashing transaction with cash back, bank server 16 supporting online banking system 22 may authorize and perform the first portion of the pre-staged transaction (i.e., the check cashing) at the time of receiving the transaction data for the pre-staged transaction. Specifically, bank server 16 may instruct the online banking application running on user computer device 12 to use a mobile remote deposit capture (MRDC) function capture images of the user's check to initiate a remote deposit or cashing of the check. Bank server 16 may analyze the check to determine what portion of the amount of the check is immediately available for withdrawal by the user. If the requested cash back amount in the pre-staged transaction is available, touchless transaction unit 24 associates the second portion of the pre-staged transaction (i.e., the cash back or fund withdrawal) with the bank account including one or more payment cards of the user. Upon the user presenting an associated payment card 30A, 30B at one of ATMs 14, ATM servers 28 and/or bank server 16 authorize performance of the second portion of the pre-staged transaction at the ATM by dispensing the amount of cash back funds to the user.

Advantageously, personal and public safety may be improved since the disclosed techniques avoid the issues of residual dirt or bacteria caused by multi-user operation at ATMs. Additionally, the user may be accustomed to user computing device 12 (e.g., the user may be relatively familiar with the layout of the one or more input and output interfaces of user computing device 12 and/or of the user interfaces of the online banking application running on user computing device 12). Thus, utilization of user computing device 12 to enter user login credentials of the user, access an account, and/or select one or more account access functions, as well as the feedback provided by user computing device 12, may be easier, less frustrating, more convenient, and/or more comfortable for a user, in comparison to the user completing an account access function using whichever ATM may be the most conveniently located for the user.

As noted above, user computing device 12 executes an online banking application that enables user computing device 12 to establish a communication session with online banking system 22 executing on bank server 16, send information to online banking system 22, receive information from online banking system 22, and/or present one or more user interfaces to receive data from a user of user computing device 12. In this way, the online banking application on user computing device 12 enables the user to interact with online banking system 22 executing on server 16 to securely access the user's bank account and request performance of one or more account access functions with the user's bank account.

The online banking application executing on user computing device 12 communicates user login credentials to online banking system 22 for authentication of the user and/or user computing device 12. For example, bank server 16 may authenticate the user of user computing device 12 based on the user login credentials, such as a user name and password or biometric information, received via a login user interface of the online banking application running on user computing device 12. In some cases, a secure communication channel may be used to communicate information and/or credentials between bank server 16 and user computing device 12. The secure communication channel helps to prevent bad actors from intercepting sensitive financial information when the user is utilizing the login user interface on user computing device 12 to exchange sensitive financial information with bank server 16. For example, data and information sent between user computing device 12 and bank server 16 may be encrypted. In some such examples, bank server 16 and user computing device 12 may establish a public key infrastructure (PKI) secure communication session over a network, such as a PAN or a WAN, e.g., network 18. Additionally, or alternatively, bank server 16 and user computing device 12 may exchange a symmetric session key to encrypt the data and information sent between bank server 16 and user computing device 12 during the established communication session.

After authentication, bank server 16 may provide access to the bank account of the authenticated user to enable performance of account access functions requested by the user via the online banking application on user computing device 12. For example, touchless transaction unit 24 of bank server 16 may receive transaction data for a pre-staged transaction via a user interface of the online banking application executing on user computing device 12, and associate the pre-staged transaction with the bank account of the user. The transaction data for the pre-staged transaction may include a type of transaction to be performed using the bank account of the user and an amount of funds for the type of transaction. For example, the user of computing device 12 may provide input specifying the pre-staged transaction as a withdrawal transaction, a fund deposit transaction, or a check cashing transaction to be performed with the bank account of the user.

In some examples, touchless transaction unit 24 may determine whether the bank account has an insufficient account balance to perform the type of transaction requested by the user based on the amount of funds input for the pre-staged transaction and an account balance of the bank account. In response determining that the bank account has an insufficient account balance, bank server 16 may send an insufficient amount balance notification to the online banking application executing on user computing device 12. In response to determining that the bank account has a sufficient account balance, touchless transaction unit 24 may associate the pre-staged transaction with one or more payment cards associated with the bank account of the user for a predetermined period of time, such as, for example, 30 minutes or one hour.

In some examples, touchless transaction unit 24 of bank server 16 may associate the pre-staged transaction with a payment card selected by the user of computing device 12. For example, the user may select a payment card of the one or more payment cards associated with the bank account of the user via a user interface of the online banking application executing on user computing device 12. The payment card selection may be communicated from the online banking application executing on user computing device 12 to online banking system 22 executing on bank server 16. Upon receiving the payment card selection, touchless transaction unit 24 may associate the pre-staged transaction with the selected payment card for a predetermined period of time. The user may then complete the pre-staged transaction, such as a pre-staged cash withdrawal transaction, by presenting the payment card associated with the pre-staged transaction at one of ATMs 14, e.g., ATM 14A, within the predetermined period of time.

In some examples, the payment card associated with the pre-staged transaction may include physical card 30A including IC chip 31 that stores identification information. ATM 14A may establish a communication session between ATM 14A and the physical card 30A such that the physical card 30A and ATM 14A can exchange messages securely. For example, the physical card 30A may be a near field communication (NFC) enabled card and may be configured to transmit an authorization request cryptogram that includes a tokenized version of the identification information and is generated by IC chip 31 in response to receiving a signal from a card reader of ATM 14A, e.g., when the physical card 30A is waved or tapped near the card reader of ATM 14A. As another example, the physical card 30A may transmit the authorization request cryptogram upon a user inserting or “dipping” the portion of the physical card 30A that includes IC chip 31 into a slot of the card reader of ATM 14A. In response to determining that the physical card 30A at ATM 14A is associated with the bank account of the user, ATM server 28 and/or bank server 16 may retrieve the pre-staged transaction associated with the user's bank account and authorize completion of the pre-staged transaction at ATM 14A.

Additionally, or alternatively, the payment card associated with the pre-staged transaction may include a virtual card 30B including a wallet token as a tokenized version of the identification information accessible via a digital wallet application running on one of user computing device 12 or user mobile device 13. The cryptogram of the virtual card 30B comprises an authorization request cryptogram that includes the wallet token and is generated by the digital wallet application when in communication with ATM 14A. In some examples, the wallet token may include a bar code or a quick response code configured to be displayed on a display device of user computing device 12 or user mobile device 13 and subsequently captured by a scanner at ATM 14A.

A user may establish a communication session between user computing device 12 or user mobile device 13 and ATM 14A by presenting the cryptogram of virtual card 30B at ATM 14A. For example, ATM 14A may detect user computing device 12 or user mobile device 13 within a predetermined distance from ATM 14A and attempt to establish a communication session with computing device 12, 13 by sending a signal from ATM 14A to the computing device 12, 13. In response to receiving the signal from ATM 14A, user computing device 12 or user mobile device 13 may transmit the cryptogram to ATM 14A. In addition, or as an alternative, the user may transmit the cryptogram of virtual card 30B from user computing device 12 or user mobile device 13 to ATM 14A by waving or tapping user computing device 12 or user mobile device 13 near a card reader of ATM 14A. ATM 14A may further send the wallet token included in the cryptogram to ATM server 28 for processing.

In some examples, upon determining that the payment card 30A, 30B at ATM 14A is associated with the bank account of the user, ATM server 28 and/or bank server 16 may identify the pre-staged transaction associated with the bank account of the user. ATM server 28 and/or bank server 16 may then authorize performance of the pre-staged transaction at ATM 14A. For example, ATM server 28 and/or bank server 16 may store an approval record of the pre-staged transaction. ATM server 28 and/or bank server 16 may further withdraw a requested amount of funds from the bank account of the user and send instructions to ATM 14A to dispense the requested amount of funds to the user.

In some examples, upon determining that the payment card 30A, 30B at the ATM 14A is associated with a bank account of a second user, ATM server 28 and/or bank server 16 may fail to identify any pre-staged transactions associated with the bank account of the second user. ATM server 28 and/or bank server 16 may then send instructions for ATM 14A to present a notification that no pre-staged transactions associated with the bank account of the second user is found. In further examples, upon determining that the payment card 30A, 30B at the ATM 14A is associated with the bank account of the user, ATM server 28 and/or bank server 16 may determine that the cryptogram was received after the predetermined period of time for the pre-staged transaction has expired. In this case, ATM server 28 and/or bank server 16 may send instructions for ATM 14A to present a notification that no pre-staged transactions associated with the bank account of the user is found.

User computing device 12 or user mobile device 13 may present additional options, provide feedback, or the like using an output interface device of the online banking application associated with online banking system 22. For example, after completion of a pre-staged transaction, user computing device 12 or user mobile device 13 may prompt the user if they would like a receipt, provide a speech output of a receipt, ask if the user would like to perform any additional account access functions, present a confirmation message, or the like. In some examples, ATM 14A and user computing device 12 or user mobile device 13 may automatically terminate the communication session upon completion of a pre-staged transaction, after any subsequent prompts or message have been presented. In this way, ATM 14A and user computing device 12 or user mobile device 13 may only have a communication session established to complete the pre-staged transaction and the communication session may be terminated once the pre-staged transaction is completed, which may reduce the likelihood of a bad actor intercepting sensitive financial information of the user.

The touchless ATM transaction described herein may enable performance of transactions via an ATM without a user having to physically touch any component of the ATM. In this way, personal and public safety may be improved, the user may feel more comfortable or safer performing an ATM-based transaction, and the ATM-based transaction may be less time consuming, frustrating, or inconvenient for the user. In addition, the touchless ATM transaction may prevent users from bringing their own cleaning supplies to ATMs and potentially damaging the physical components of the ATMs.

In addition, the touchless ATM transaction may be more secure than conventional ATM-based transactions. For example, the touchless ATM transaction described herein uses two-factor authentication that includes validated user login credentials to the online banking system for pre-staging the transaction (i.e., what you know) plus physical position of a physical payment card or a wallet token of a virtual payment card to provide the payment card cryptogram received by the ATM (i.e., what you have) to authenticate the user and authorize the transaction at the ATM.

This may provide a higher level of security compared to a conventional ATM transaction that uses a payment card cryptogram plus a user's static PIN both received from the ATM. A static PIN entered at a public ATM may be relatively easy to steal, learn, or guess compared to user login credentials. For example, the user login credentials may be entered in a private location via a user computing device or a user mobile device prior to the user arriving at the public ATM. In addition, the user login credentials may include biometric information (e.g., a user's fingerprint) and/or a user name and password combination that may be required to periodically change. Moreover, in the case of a virtual payment card, a fraudster would need to gain access to both the online banking application running on the user computing device and the digital wallet application running on the same or a different device, which may each have different user authentication requirements.

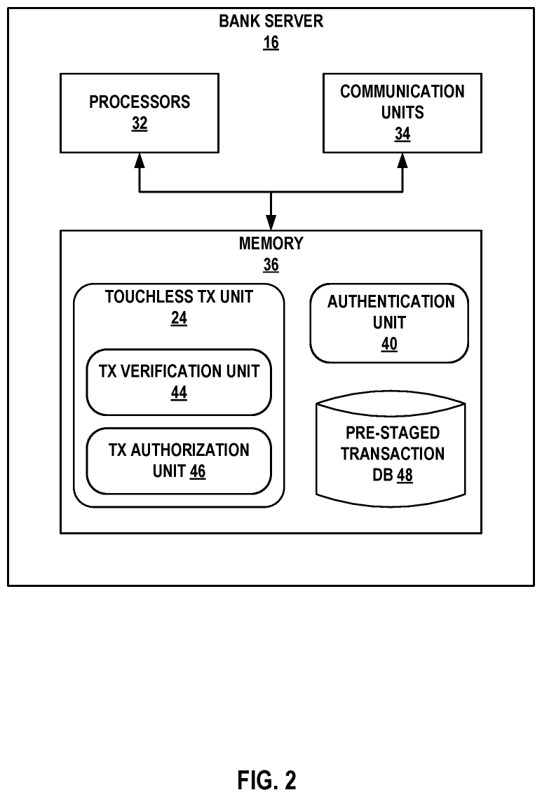

FIG. 2 is a block diagram illustrating an example bank server 16 configured to facilitate touchless ATM transactions, in accordance with the techniques of this disclosure. The architecture of bank server 16 illustrated in FIG. 2 is shown for exemplary purposes only. Bank server 16 should not be limited to the illustrated example architecture. In other examples, bank server 16 may be configured in a variety of ways.

As shown in the example of FIG. 2, bank server 16 includes one or more processors 32, one or more communication units 34, and one or more memory units 36. Bank server 16 includes touchless transaction (TX) unit 24 including a transaction (TX) verification unit 44 and a transaction (TX) authorization unit 46, and authentication unit 40, each of which may be implemented as program instructions and/or data stored in memory 36 and executable by processors 32 or implemented as one or more hardware units or devices of bank server 16. In the example of FIG. 2, memory 36 stores a pre-staged transaction database 48, but in other examples such a database may be stored in a data center or storage network of bank network 20 of FIG. 1. Memory 36 of bank server 16 may also store an operating system (not shown) executable by processors 32 to control the operation of components of bank server 16. Although not shown in FIG. 2, the components, units, or modules of bank server 16 are coupled (physically, communicatively, and/or operatively) using communication channels for inter-component communications. In some examples, the communication channels may include a system bus, a network connection, an inter-process communication data structure, or any other method for communicating data.

Processors 32, in one example, may comprise one or more processors that are configured to implement functionality and/or process instructions for execution within bank server 16. For example, processors 32 may be capable of processing instructions stored by memory 36. Processors 32 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Memory 36 may be configured to store information within bank server 16 during operation. Memory 36 may include a computer-readable storage medium or computer-readable storage device. In some examples, memory 36 include one or more of a short-term memory or a long-term memory. Memory 36 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory 36 is used to store program instructions for execution by processors 32. Memory 36 may be used by software or applications running on bank server 16 (e.g., touchless transaction unit 24 and/or authentication unit 40) to temporarily store information during program execution.

Bank server 16 may utilize communication units 34 to communicate with external devices via one or more networks, e.g., network 18 and/or bank network 20 of FIG. 1. Communication units 34 may be network interfaces, such as Ethernet interfaces, optical transceivers, radio frequency (RF) transceivers, or any other type of devices that can send and receive information. Other examples of such network interfaces may include Wi-Fi, NFC, or Bluetooth® radios. In some examples, bank server 16 utilizes communication unit 34 to wirelessly communicate with external devices, e.g., user computing device 12 and ATM servers 28 of ATM system 26 of FIG. 1, or other computing devices within bank network 20.

In accordance with the techniques described in this disclosure, bank server 16 enables a user to initiate a touchless ATM transaction. Bank server 16 comprises at least one server configured to support online banking system 22. Communication units 34 of bank server 16 may facilitate establishment of a communication session between an online banking application running on a user computing device, e.g., user computing device 12 of FIG. 1, and online banking system 22.

Authentication unit 40 of bank server 16 performs user authentication to provide users with secure access to their bank accounts via online banking system 20. More specifically, authentication unit 40 receives user login credentials (e.g., biometric information, a user name and password, or the like) for a bank account of the user via a login user interface of the online banking application running on the user computing device of the user, e.g., user computing device 12 of FIG. 1. Authentication unit 40 compares the received user login credentials against stored credentials for the user. The stored credentials may be securely held in a data center or storage network of bank network 20 and accessibly by bank server 16 via communication units 34. Based on validating the user login credentials, authentication unit 40 authenticates the user to access the bank account via the online banking application running on the user computing device.

Upon receiving access to the bank account, the user may initiate a touchless ATM transaction with the bank account via online banking system 22. Touchless transaction unit 24 of bank server 16 receives transaction data for a pre-staged transaction from the user computing device via a user interface of the online banking application. In some examples, touchless transaction unit 24 may receive input specifying a type of transaction and an amount of funds for the type of transaction. Transaction verification unit 44 may verify that the type of transaction can be performed using the bank account and that the bank account has an account balance that is sufficient to perform the type of transaction for the amount of funds. This verification step ensures accuracy of the requested pre-staged transaction and preemptively identifies any potential issues that may result in failure to complete the pre-staged transaction before the user arrives at an ATM.

Touchless transaction unit 24 associates the pre-staged transaction with the bank account of the user including one or more payment cards of the user. Touchless transaction unit 24 may associate the pre-staged transaction with the bank account of the user including the one or more payment cards for a predetermined period of time, e.g., 30 minutes or 1 hour from verification of the requested pre-staged transaction. In some examples, instead of associating the pre-staged transaction with all payment cards of the bank account, touchless transaction unit 24 may receive input specifying a selected payment card of the one or more payment cards of the bank account, and associate the pre-staged transaction with the selected payment card for the predetermined period of time. Touchless transaction unit 24 may store the pre-staged transaction in pre-staged transaction database 48. For example, database 48 may include an entry for each per-staged transaction requested by the user along with the associated bank account or particular payment card, a time stamp of when the requested transaction was verified, and the predetermined period of time for which the pre-staged transaction is valid. In some examples, when the pre-staged transaction is no longer valid, i.e., the predetermine period of time has expired, the entry for the pre-staged transaction may be removed from database 48.

In some examples, after associating the pre-staged transaction with the bank account or the particular payment card, touchless transaction unit 24 may utilize communication units 34 of bank server 16 to send a list of pre-staged transactions to one or more of ATM servers 28 of the ATM system 26. As described in more detail below, in some scenarios, an ATM server 28 of ATM system 26 may authorize performance of the pre-staged transaction at an ATM based on the list of pre-staged transactions received from bank server 16 or other servers supporting online banking system 22.

In other scenarios, an ATM server 28 may communicate with bank server 16 upon receipt of a cryptogram of a payment card from an ATM such that bank server 16 authorizes performance of the pre-staged transaction at the ATM. In this scenario, touchless transaction unit 24 of bank server 16 may receive the cryptogram of the payment card or the identification information included in the cryptogram of the payment card from ATM server 28. Transaction authorization unit 46 may determine, based on identification information included in the cryptogram of the payment card, that the payment card at the ATM is associated with the pre-staged transaction. For example, transaction authorization unit 46 may determine that the cryptogram of the payment card at the ATM is associated with the pre-staged transaction based on the cryptogram of the payment card being received by the ATM during the predetermined period of time for the pre-staged transaction.

More specifically, transaction authorization unit 46 may perform a lookup in pre-staged transaction database 48 to determine whether an entry exists in database 48 that matches the bank account or particular payment card identified by the identification information included in the cryptogram of the payment card at the ATM. In some cases, if an entry is found in database 48, transaction authorization unit 46 may determine whether the time stamp at which the cryptogram was received by the ATM is within the predetermined period of time for the pre-staged transaction. In other cases, if the predetermined period of time for the pre-staged transaction has expired, the entry would be removed from database 48 such that transaction authorization unit 46 would not find a matching entry.

Upon determining that the payment card at the ATM is associated with the pre-staged transaction, transaction authorization unit 46 may authorize performance of the pre-staged transaction at the ATM. For example, transaction authorization unit 46 may use communication units 34 to communicate the authorization to the ATM server 28 from which the cryptogram or identification information was received, and the ATM server 28 may then communicate the authorization to the ATM. Transaction authorization unit 46 may initiate the transfer of funds with the bank account of the user and send any necessary instructions to the ATM, via ATM server 28, to dispense or receive funds. In examples where transaction authorization unit 46 determines that the pre-staged transaction has expired or is not found in database 48, transaction authorization unit 46 requests ATM server 28 to send instructions for the ATM to present a notification that no pre-staged transaction associated with the payment card is found.

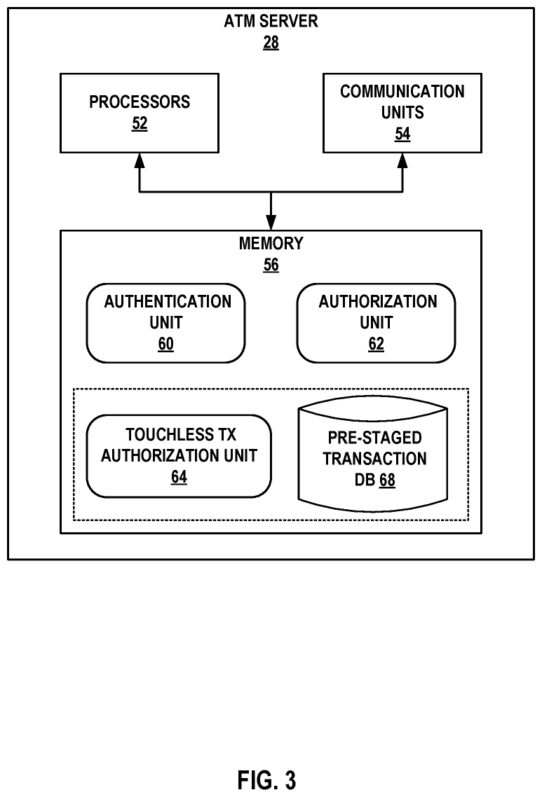

FIG. 3 is a block diagram illustrating an example ATM server 28 configured to facilitate touchless ATM transactions, in accordance with the techniques of this disclosure. The architecture of ATM server 28 illustrated in FIG. 3 is shown for exemplary purposes only. ATM server 28 should not be limited to the illustrated example architecture. In other examples, ATM server 28 may be configured in a variety of ways.

As shown in the example of FIG. 3, ATM server 28 includes one or more processors 52, one or more communication units 54, and one or more memory units 56. ATM server 28 includes authentication unit 60, authorization unit 62, and, in some examples, touchless transaction (TX) authorization unit 64, each of which may be implemented as program instructions and/or data stored in memory 36 and executable by processors 32 or implemented as one or more hardware units or devices of bank server 16. In some examples, memory 56 stores a pre-staged transaction database 68, but in other examples such a database may be stored in a data center or storage network of bank network 20 of FIG. 1. Memory 56 of ATM server 28 may also store an operating system (not shown) executable by processors 52 to control the operation of components of ATM server 28. Although not shown in FIG. 3, the components, units, or modules of bank server 16 are coupled (physically, communicatively, and/or operatively) using communication channels for inter-component communications. In some examples, the communication channels may include a system bus, a network connection, an inter-process communication data structure, or any other method for communicating data.

Processors 52, in one example, may comprise one or more processors that are configured to implement functionality and/or process instructions for execution within ATM server 28. For example, processors 52 may be capable of processing instructions stored by memory 56. Processors 52 may include, for example, microprocessors, DSPs, ASICs, FPGAs, or equivalent discrete or integrated logic circuitry, or a combination of any of the foregoing devices or circuitry.

Memory 56 may be configured to store information within ATM server 28 during operation. Memory 56 may include a computer-readable storage medium or computer-readable storage device. In some examples, memory 56 include one or more of a short-term memory or a long-term memory. Memory 56 may include, for example, RAM, DRAM, SRAM, magnetic discs, optical discs, flash memories, or forms of EPROM or EEPROM. In some examples, memory 56 is used to store program instructions for execution by processors 52. Memory 56 may be used by software or applications running on ATM server 28 (e.g., authentication unit 60, authorization unit 62, and/or touchless transaction authorization unit 64) to temporarily store information during program execution.

ATM server 28 may utilize communication units 54 to communicate with external devices via one or more networks, e.g., network 18 and/or bank network 20 of FIG. 1. Communication units 54 may be network interfaces, such as Ethernet interfaces, optical transceivers, RF transceivers, or any other type of devices that can send and receive information. Other examples of such network interfaces may include Wi-Fi, NFC, or Bluetooth® radios. In some examples, ATM server 28 utilizes communication unit 54 to wirelessly communicate with external devices, e.g., ATMs 14 and bank server 16 of online banking system 22 of FIG. 1, or other computing devices within bank network 20.

In accordance with the techniques described in this disclosure, ATM server 28 enables a user to complete a touchless ATM transaction based on a pre-staged transaction previously requested via online banking system 22. ATM server 28 comprises at least one ATM server within ATM system 26 that is in communication with a plurality of ATMs 14. Communication units 54 of ATM server 28 may facilitate establishment of a communication session with a server supporting online banking system 22, e.g., bank server 16 of FIGS. 1 and 2, and establishment of communication sessions with one or more ATMs 14.

To initiate an ATM transaction, ATM server 28 receives a cryptogram of a payment card from an ATM 14. According to the techniques described herein, authentication unit 60 of ATM server 28 may first determine, based on identification information included in the cryptogram of the payment card, whether the payment card at the ATM is associated with a pre-staged transaction. In some scenarios, as described above with respect to FIG. 2, authentication unit 60 may send the cryptogram of the payment card or the identification information included in the cryptogram of the payment card to bank server 16 to identify and authorize any associated pre-staged transaction.

In other scenarios, ATM server 28 stores a list of pre-staged transaction received from bank server 16 in pre-staged transaction database 68. Similar to database 48 of bank server 16 from FIG. 2, database 68 may include an entry for each per-staged transaction along with the associated bank account or particular payment card, a time stamp of when the requested transaction was verified, and the predetermined period of time for which the pre-staged transaction is valid. In some examples, when the pre-staged transaction is no longer valid, i.e., the predetermine period of time has expired, the entry for the pre-staged transaction may be removed from database 68.

In the latter scenarios, touchless transaction authorization unit 64 of ATM server 28 may determine, based on identification information included in the cryptogram of the payment card, that the payment card at the ATM is associated with the pre-staged transaction. For example, touchless transaction authorization unit 64 may determine that the cryptogram of the payment card at the ATM is associated with the pre-staged transaction based on the cryptogram of the payment card being received by the ATM during the predetermined period of time for the pre-staged transaction.

More specifically, touchless transaction authorization unit 64 may perform a lookup in pre-staged transaction database 68 to determine whether an entry exists in database 68 that matches the bank account or particular payment card identified by the identification information included in the cryptogram of the payment card at the ATM. In some cases, if an entry is found in database 68, touchless transaction authorization unit 64 may determine whether the time stamp at which the cryptogram was received by the ATM is within the predetermined period of time for the pre-staged transaction. In other cases, if the predetermined period of time for the pre-staged transaction has expired, the entry would be removed from database 68 such that touchless transaction authorization unit 64 would not find a matching entry.

Upon determining that the payment card at the ATM is associated with the pre-staged transaction, touchless transaction authorization unit 64 may authorize performance of the pre-staged transaction at the ATM. For example, touchless transaction authorization unit 64 may use communication units 54 to communicate with bank server 16 of online banking system 22 to initiate the transfer of funds with the bank account of the user for the pre-staged transaction. In addition, touchless transaction authorization unit 64 may use communication units 54 to communicate the authorization to the ATM and/or send any necessary instructions to the ATM to dispense or receive funds.

In examples where touchless transaction authorization unit 64 determines that the pre-staged transaction has expired or is not found in database 68, touchless transaction authorization unit 64 sends instructions for the ATM to present a notification that no pre-staged transaction associated with the payment card is found. In addition, when no pre-staged transaction associated with the payment card is found, touchless transaction authorization unit 64 may send instructions for the ATM to resume traditional operation. For example, authentication unit 60 of ATM server 28 may receive a PIN, an OTP, or an access code entered by the user at the ATM and attempt to authenticate the user based on the traditional combination of the payment card cryptogram and the user's PIN or other code. Authorization unit 62 may then receive transaction requests entered by the user at the ATM and perform traditional authorization processes to authorize or deny the requested transactions.

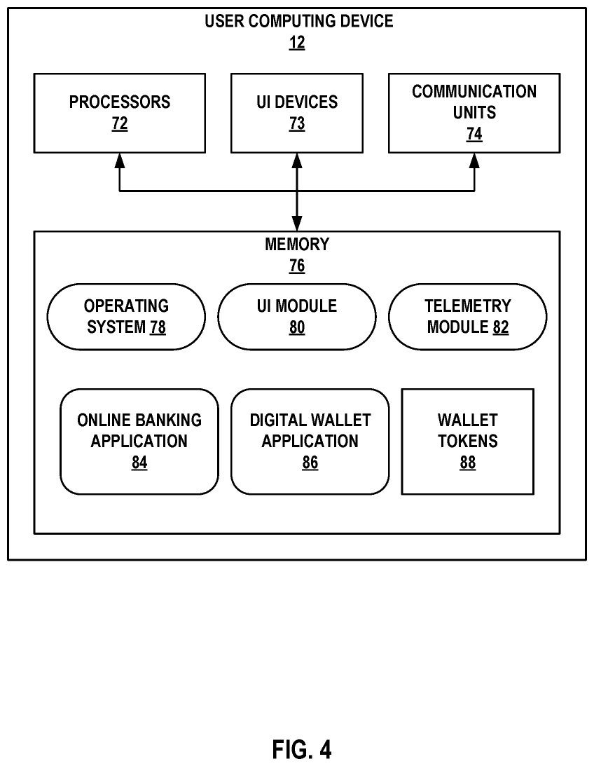

FIG. 4 is a block diagram illustrating an example user computing device 12 configured to initiate touchless ATM transactions, in accordance with the techniques of this disclosure. The architecture of user computing device 12 illustrated in FIG. 4 is shown for exemplary purposes only and user computing device 12 should not be limited to this architecture. In other examples, user computing device 12 may be configured in a variety of ways.

As shown in the example of FIG. 4, user computing device 12 includes one or more processors 72, one or more user interface (UI) devices 73, one or more communication units 74, and one or more memory units 76. Memory 76 of user computing device 12 includes operating system 78, UI module 80, telemetry module 82, online banking application 84, and digital wallet application 86, which are executable by processors 72. Memory 76 also stores one or more wallet tokens 88 for one or more payment cards included in digital wallet application 86. Each of the components, units, or modules of user computing device 12 are coupled (physically, communicatively, and/or operatively) using communication channels for inter-component communications. In some examples, the communication channels may include a system bus, a network connection, an inter-process communication data structure, or any other method for communicating data.

Processors 72, in one example, may include one or more processors that are configured to implement functionality and/or process instructions for execution within user computing device 12. For example, processors 72 may be capable of processing instructions stored by memory 76. Processors 72 may include, for example, microprocessors, DSPs, ASICS, FPGAs, or equivalent discrete or integrated logic circuitry, or a combination of any of the foregoing devices or circuitry.

Memory 76 may be configured to store information within user computing device 12 during operation. Memory 76 may include a computer-readable storage medium or computer-readable storage device. In some examples, memory 76 includes one or more of a short-term memory or a long-term memory. Memory 76 may include, for example, RAM, DRAM, SRAM, magnetic discs, optical discs, flash memories, or forms of EPROM, or EEPROM. In some examples, memory 76 is used to store program instructions for execution by processors 72. Memory 76 may be used by software or applications running on user computing device 12 (e.g., online banking application 84 and/or digital wallet application 86) to temporarily store information during program execution.

User computing device 12 may utilize communication units 74 to communicate with external devices via one or more networks, e.g., bank server 16 of online banking system 22 via network 18 from FIG. 1, or proximate external devices via wireless signals, e.g., ATMs 14 from FIG. 1. Communication units 74 may be network interfaces, such as Ethernet interfaces, optical transceivers, RF transceivers, or any other type of devices that can send and receive information. Other examples of interfaces may include Wi-Fi, NFC, or Bluetooth® radios.

UI devices 73 may be configured to operate as both input devices and output devices. For example, UI devices 73 may be configured to receive tactile, audio, or visual input from a user of user computing device 12. In addition to receiving input from a user, UI devices 73 may be configured to provide output to a user using tactile, audio, or video stimuli. In one example, UI devices 73 may input and output interfaces such as a keypad, a touch screen, a microphone, a speaker, a headphone jack, a vibration motor, and/or an actuator. UI devices 73 may include a presence-sensitive display that receives input from a user using capacitive, inductive, and/or optical detection at or near the presence sensitive display. Other examples of UI devices 73 include any other type of device for detecting a command from a user, a sound card, a video graphics adapter card, or any other type of device for converting a signal into an appropriate form understandable to humans or machines. In some examples, UI devices 73 include devices to provide output to a visually impaired user (e.g., intelligible auditory and/or tactile output).

Operating system 78 controls the operation of components of user computing device 12. For example, operating system 78, in one example, facilitates the communication of UI module 80, telemetry module 82, online banking application 84, and digital wallet application 86 with processors 72, UI devices 73, communication units 74, and memory 76. UI module 80, telemetry module 82, online banking application 84, and digital wallet application 86 may each include program instructions and/or data stored in memory 76 that are executable by processors 72. For example, online banking application 84 and digital wallet application 86 may each include instructions that cause user computing device 12 to perform one or more of the techniques described herein.

UI module 80 may be software and/or hardware configured to interact with one or more UI devices 73. For example, UI module 80 may generate audio or tactile output, such as speech or haptic output, to be transmit to a user through one or more UI devices 73. In some examples, UI module 80 may process an input after receiving it from one of UI devices 73, or UI module 80 may process an output prior to sending it to one of UI devices 73.

Telemetry module 82 may be software and/or hardware configured to interact with one or more communication units 74. Telemetry module 82 may generate and/or process data packets sent or received using communication units 74. In some examples, telemetry module 82 may process one or more data packets after receiving it from one of communication units 74. In other examples, telemetry module 82 may generate one or more data packets or process one or more data packets prior sending it via communication units 74.

User computing device 12 may include additional components that, for clarity, are not shown in FIG. 4. For example, user computing device 12 may include a battery to provide power to the components of user computing device 12. Similarly, the components of user computing device 12 shown in FIG. 4 may not be necessary in every example of user computing device 12.

In accordance with the techniques described in this disclosure, user computing device 12 may enable a user to initiate a touchless ATM transaction with an online banking system, e.g., online banking system 22 of FIG. 1, via online banking application 84. Online banking application 84 may be a mobile-based application executing on user computing device 12 or a web-based application accessible via a browser executing on user computing device 12. The user may open online banking application 84 in order to log into the user's bank account via online banking system 22. For example, online banking application 84 and UI module 80 may generate a login user interface for display on a display device of UI devices 73 and receive user login credentials (e.g., biometric information, a user name and password, or the like) via the display device or other of UI devices 73.

Upon validation of the user login credentials by a bank server supporting online banking system 22, e.g., bank server 16 of FIG. 1, online banking application 84 and UI module 80 may generate a user interface for display on the display device of UI devices 73 to receive transaction requests and, in particular, transaction data for a pre-staged transaction to initiate a touchless ATM transaction. For example, the user interface may receive input specifying a type of transaction and an amount of funds for the type of transaction. In response, the user interface may display a notification indicating whether the requested pre-staged transaction is verified. If the pre-staged transaction is not verified, the user interface may provide an opportunity for the user to reenter the transaction data. If the pre-staged transaction is verified, the user interface may display a notification indicating the time window in which the pre-staged transaction must be completed at an ATM.

In some examples, user computing device 12 may comprises a user mobile device, e.g., user mobile device 13 of FIG. 1. In the example of FIG. 4, user computing device 12 includes a digital wallet application 86 having one or more virtual payment cards and wallet tokens 88 to enable transactions between the virtual payment cards and contactless card readers. For example, one of the virtual payment cards within digital wallet application 86 may be associated with a current pre-staged transaction. Upon the user carrying user computing device 12 coming within a certain distance of an ATM and in response to a short-range signal emitted by a card reader of the ATM, digital wallet application 86 may generate an authorization request cryptogram that includes one of wallet tokens 88 as a tokenized version of the identification information for the virtual payment card. In this way, the user may complete the pre-staged transaction at the ATM without physically touching any component of the ATM.

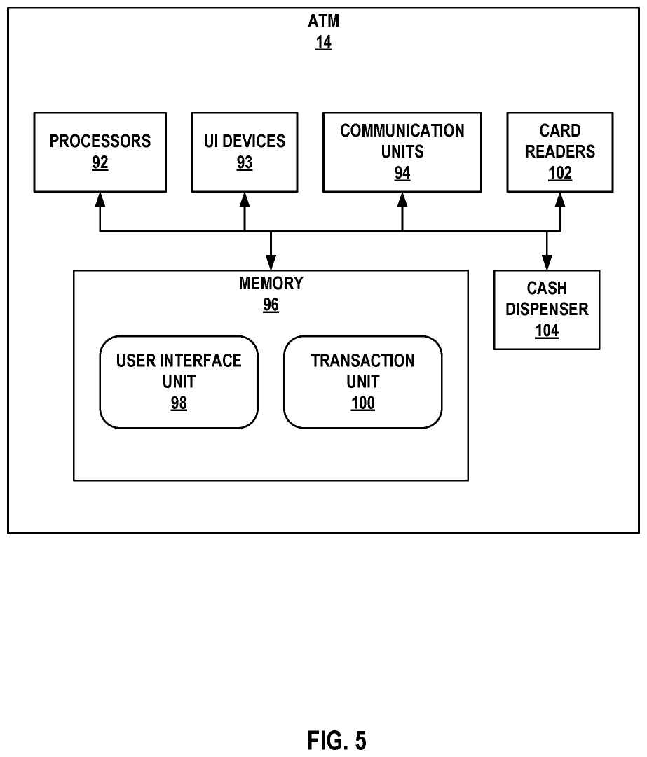

FIG. 5 is a block diagram illustrating an example ATM 14, in accordance with aspects of the disclosure. The architecture of ATM 14 illustrated in FIG. 5 is shown for exemplary purposes only, and ATM 14 should not be limited to this architecture. In some examples, ATM 14 may include additional components that, for clarity, are not shown in FIG. 5. In other examples, ATM 14 may be configured in a variety of ways.

As shown in the example of FIG. 5, ATM 14 includes one or more processors 92, one or more UI devices 93, one or more communication units 94, one or more memory units 96, one or more card readers 102, and a cash dispenser 104. ATM 14 also includes user interface unit 98 and transaction unit 100, each of which may be implemented as program instructions and/or data stored in memory 96 and executable by processors 92 or implemented as one or more hardware units or devices of ATM 14. In some examples, memory 96 of ATM 14 may also store an operating system executable by processors 92. The operating system stored in memory 96 may control the operation of components of ATM 14. The components, units or modules of ATM 14 are coupled (physically, communicatively, and/or operatively) using communication channels for inter-component communications. In some examples, the communication channels may include a system bus, an inter-process communication data structure, or any other method for communicating data.

Processors 92, in one example, may include one or more processors that are configured to implement functionality and/or process instructions for execution within ATM 14. For example, processors 92 may be capable of processing instructions stored by memory 96. Processors 92 may include, for example, microprocessors, DSPs, ASICs, FPGAs, or equivalent discrete or integrated logic circuitry, or a combination of any of the foregoing devices or circuitry.

Memory 96 may be configured to store information within ATM 14 during operation. Memory 96 may include a computer-readable storage medium. In some examples, memory 96 includes one or more of a short-term memory or a long-term memory. Memory 96 may include, for example, RAM, DRAM, SRAM, magnetic discs, optical discs, flash memories, or forms of EPROM or EEPROM. In some examples, memory 96 is used to store program instructions for execution by processors 92. Memory 96 may be used by software running on ATM 14 (e.g., user interface unit 98 and/or transaction unit 100) to temporarily store information during program execution.

ATM 14 may utilize communication units 94 to communicate with external devices via one or more networks, e.g., ATM servers 28 of ATM system 26 via network 18 from FIG. 1, or via wireless signals. Communication units 94 may be network interfaces, such as Ethernet interfaces, optical transceivers, RF transceivers, or any other type of devices that can send and receive information. Other examples of interfaces may include Wi-Fi, NFC, or Bluetooth® radios. In some examples, ATM 14 utilizes communication units 94 to wirelessly communicate with proximate external devices, such as user computing device 12, user mobile device 13, and/or physical card 30A from FIG. 1.

ATM 14 may include UI devices 93 to communicate with some users of ATM 14. UI devices 93 may be configured to operate as both input devices and output devices. For example, UI devices 93 may be configured to receive tactile, audio, or visual input from a user of ATM 14. In addition to receiving input from a user, UI devices 93 may be configured to provide output to a user using tactile, audio, or video stimuli. In one example, UI devices 93 may be configured to output content for display, e.g., a GUI, in accordance with user interface unit 98 stored in memory 96. In some such examples, UI devices 93 may include a presence-sensitive display that displays a GUI and receives input from a user using capacitive, inductive, and/or optical detection at or near the presence sensitive display. Other examples of UI devices 93 include a keypad, touchpad, a voice responsive system, video camera, microphone, or any other type of device for detecting a command from a user, or a sound card, a video graphics adapter card, or any other type of device for converting a signal into an appropriate form understandable to humans or machines. Additional examples of UI devices 93 include a speaker, a CRT monitor, a LCD, OLED, or any other type of device that can generate intelligible output to a user.

ATM 14 includes one or more card readers 102 configured to read or otherwise receive cryptograms from payment cards, e.g., physical payment card 30A and/or virtual payment card 30B from FIG. 1. For example, card readers 95 may include a dip card reader configured to receive a cryptogram upon the user inserting or dipping a portion of the physical payment card 30A that includes IC chip 31 into a slot of the dip card reader. In addition, card readers 95 may include a contactless card reader configured to emit a short-range signal requesting information from any payment cards brought near the contactless card reader such that the contactless card reader may receive the cryptogram from IC chip 31 of physical card 30A in response to the user waving or tapping physical card 30A near the contactless card reader. The contactless card reader may similarly receive the cryptogram from virtual card 30B in response to the user waving or tapping user computed device 12 or user mobile device 13 executing the digital wallet application near the contactless card reader. ATM 14 further includes a cash dispenser 104 configured to dispense a requested amount of funds in the form of banknotes via an opening in an exterior housing of ATM 14. In some examples, cash dispenser 104 may dispense the banknotes within an envelope.

ATM 14 may include additional components that, for clarity, are not shown in FIG. 5. Similarly, the components of ATM 14 shown in FIG. 5 may not be necessary in every example of ATM 14.

In accordance with the techniques described in this disclosure, ATM 14 is configured to receive the cryptogram of the payment card via one of card readers 102 and, prior to prompting a user of the payment card for authentication information via a user interface, ATM 14 may send the cryptogram to an ATM server to identify and authorize a touchless ATM transaction. Traditionally, in order to authenticate the user to access a bank account or perform a transaction via an ATM, the user needs to press keys on a physical keyboard, select options on a touch-sensitive display screen, or otherwise physically touch one of UI devices 94 with one or more fingers. The techniques described herein enable the user to instead pre-stage a transaction with an online banking system, e.g., online banking system 22 of FIG. 1, and complete the pre-staged transaction at ATM 14 by providing the cryptogram of a payment card associated with the pre-staged transaction. As described above, card readers 102 are configured to receive payment card-generated cryptograms without the user needing to physically touch any component of ATM 14.

Upon receipt of a cryptogram from a payment card via one or card readers 102, user interface unit 98 of ATM 14 may generate a user interface for display on a display device of UI devices 93 to present a notification to the user that the payment card has been read and is being evaluated for associated pre-staged transactions. In other examples, the user interface may provide a notification to the user to wait before attempting to enter additional authentication information, e.g., a PIN, OTP, or access code, via one of UI devices 93. In still other examples, a unique user interface for the touchless ATM transactions may not be generated or displayed.

Continuing the above example, upon receipt of the cryptogram from the payment card via one or card readers 102, transaction unit 100 of ATM 14 uses communication units 94 to send the cryptogram to an ATM server, e.g., ATM server 28 of FIG. 1. If the ATM server and/or a bank server supporting online banking system 22 identifies an associated pre-staged transaction for the payment card and authorizes performance for the pre-staged transaction, transaction unit 100 receives the authorization via communication units 94 and performs the transaction. In some examples, if the transaction is an account balance check, check cashing, or a fund transfer, user interface unit 98 may generate a user interface to present a notification to the user that the pre-staged transactions as been completed. In other examples, if the transaction is a withdrawal or a fund deposit, transaction unit 100 may use cash dispenser 104 to dispense the amount of funds for the pre-staged transaction to the user or may use cash dispenser 104 or another receptacle of ATM 14 to receive the amount of funds (e.g., in the form of cash or check) for the pre-staged transaction. Cash dispenser 104 and other receptacles of ATM 14 may be configured such that the user need only touch the cash, check, or an envelope to remove or insert funds while not physically touching any component of ATM 14.

If the ATM server and/or a bank server supporting online banking system 22 does not identify an associated pre-staged transaction for the payment card, transaction unit 100 receives a “transaction not found” notification via communication units 94. In some examples, user interface unit 98 may generate a user interface to present the notification to the user that no pre-staged transaction associated with the payment card is found. When no pre-staged transaction associated with the payment card is found, ATM 14 may resume traditional operations.

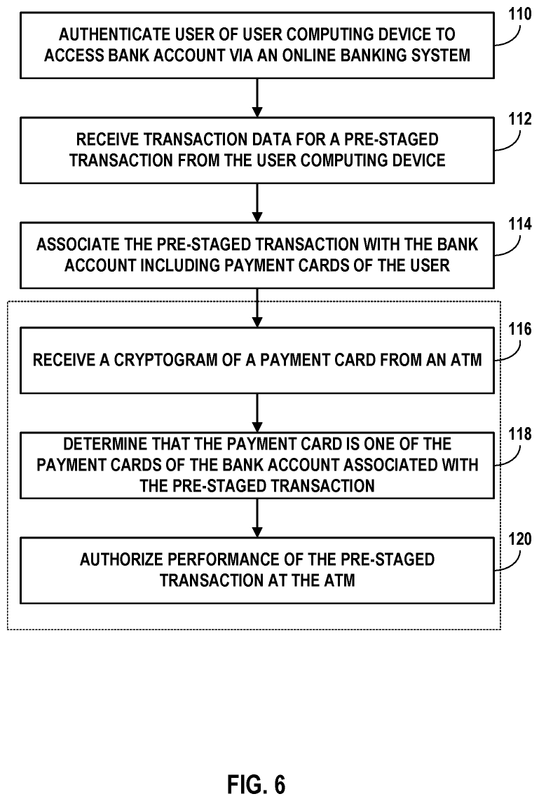

FIG. 6 is a flow chart illustrating an example operation of a server device to facilitate a touchless ATM transaction for a user, in accordance with aspects of the disclosure. The example technique of FIG. 6 will be described with respect to bank server 16 and ATM server 28 within network system 10 of FIG. 1.

Bank server 16 of online banking system 22 receives user login credentials (e.g., biometric information, a user name and password, or the like) for a bank account of a user via a login user interface of an online banking application on user computing device 12 of the user. Bank server 16 authenticates the user to access the bank account via the online banking application on user computing device 12 based on validating the user login credentials (110).

Bank server 16 may then receive transaction data for a pre-staged transaction from user computing device 12 via the user interface of the online banking application (112). In some examples, bank server 16 may receive input specifying a type of transaction and an amount of funds for the type of transaction, and verify that the type of transaction can be performed using the bank account and that the bank account has an account balance that is sufficient to perform the type of transaction for the amount of funds.

Touchless transaction unit 24 of bank server 16 associates the pre-staged transaction with the bank account of the user including one or more payment cards of the user (114). Touchless transaction unit 24 may associate the pre-staged transaction with the bank account of the user including the one or more payment cards for a predetermined period of time. In some examples, instead of associating the pre-staged transaction with all payment cards of the bank account, bank server 16 may receive a selected payment card of the one or more payment cards of the bank account, and associate the pre-staged transaction with the selected payment card for the predetermined period of time. In some examples, after associating the pre-staged transaction with the bank account, bank server 16 may send a list of pre-staged transactions, including the pre-staged transaction associated with the bank account, to one or more ATM servers 28 of the ATM system 26.

The above described steps may be performed between a user computing device, e.g., a user's mobile device or a user's home computer, and bank server to setup a pre-staged transaction to enable a subsequent touchless transaction at an ATM. The online banking application may be a mobile-based application executing on the user computing device or a web-based application accessible via a browser executing on the user computing device. The below described steps (included within a dotted-line box in FIG. 6) are performed between an ATM and an ATM server and/or the bank server to validate and perform the touchless transaction subsequent to setting up the pre-staged transaction.

ATM server 28 receives a cryptogram of a payment card from ATM 14A (116). ATM 14A may receive the cryptogram of the payment card when the payment card is proximate to ATM 14A. In one example, the payment card used to initiate the touchless transaction at ATM 14A may be a physical card 30A including an IC chip 31 that stores the identification information. In this example, the cryptogram of the payment card comprises an authorization request cryptogram that includes a tokenized version of the identification information and is generated by the IC chip 31 when in communication with ATM 14A. In one scenario, a card reader of ATM 14A may receive the cryptogram from IC chip 31 of physical card 30A in response to the user inserting or dipping physical card 30A into a slot of the card reader. In another scenario, a card reader of ATM 14A may emit a short-range signal requesting information from any payment cards brought near the card reader such that the card reader may receive the cryptogram from IC chip 31 of physical card 30A in response to the user waving or tapping physical card 30A near the card reader. In either scenario, the card reader may be configured such that the user need only touch physical card 30A to insert or tap physical card 30A while not physically touching any component of ATM 14A.

In another example, the payment card used to initiate the touchless transaction at ATM 14A may be a virtual card 30B including a wallet token as a tokenized version of the identification information accessible via a digital wallet application running on one of user computing device 12 or a user mobile device 13. In this example, the cryptogram of the payment card comprises an authorization request cryptogram that includes the wallet token and is generated by the digital wallet application when in communication with ATM 14A. In one scenario, a card reader of ATM 14A may emit a short-range signal requesting information from any payment cards brought near the card reader such that the card reader may receive the cryptogram from virtual card 30B in response to the user waving or tapping user computing device 12 or user mobile device 13 executing the digital wallet application near the card reader. In this scenario, the card reader may be configured such that the user need only touch user computing device 12 or user mobile device 13 to tap the digital wallet application that includes virtual card 30B while not physically touching any component of ATM 14A.

ATM server 28 determines, based on identification information included in the cryptogram of the payment card, that the payment card at ATM 14A is one of the one or more payment cards of the bank account associated with the pre-staged transaction (118). For example, ATM server 28 may determine that the payment card is associated with the pre-staged transaction from a list of pre-staged transactions received from bank server 16. In other examples, ATM server 28 may send the cryptogram of the payment card or send the identification information included in the cryptogram of the payment card to bank server 16 to process the pre-staged transaction. For example, ATM server 28 and/or bank server 16 may determine that the payment card at ATM 14A is associated with the pre-staged transaction based on the cryptogram of the payment card being received by ATM 14A during a predetermined period of time for the pre-staged transaction. In some examples, ATM server 28 and/or bank server 16 may determine that the payment card at ATM 14A is the selected payment card of the bank account associated with the pre-staged transaction, and determine that the cryptogram of the selected payment card is received by ATM 14A during the predetermined period of time for the pre-staged transaction.

Upon determining that the payment card at ATM 14A is associated with the pre-staged transaction, ATM server 28 may authorize performance of the pre-staged transaction at ATM 14A (120). In examples where the pre-staged transaction at least in part comprises a cash withdrawal, ATM server 28 may withdraw an amount of funds for the cash withdrawal from the bank account of the user, and send instructions for ATM 14A to dispense the amount of funds to the user via a cash dispenser at ATM 14A. The cash dispenser may be configured such that the user need only touch the cash or an envelope to remove the cash from the cash dispenser while not physically touching any component of ATM 14A.

In scenarios where ATM server 28 and/or bank server 16 determine that no pre-staged transaction is associated with the payment card at ATM 14A, ATM server 28 may send instructions for ATM 14A to present a notification that no pre-staged transaction associated with the payment card is found. In other scenarios where ATM server 28 and/or bank server 16 determine that the cryptogram of the payment card is received by ATM 14A after the predetermined period of time for the pre-staged transaction associated with the payment card has expired, ATM server 28 may send instructions for ATM 14A to present a notification that no pre-staged transaction associated with the payment card is found.

The touchless ATM transaction described herein may enable performance of transactions via an ATM without a user having to physically touch any component of the ATM. In addition, the touchless ATM transaction may be more secure than conventional ATM-based transactions. For example, the touchless ATM transaction described herein uses validated user login credentials to the online banking system for pre-staging the transaction plus the payment card cryptogram received from the ATM to authenticate the user and authorize the transaction at the ATM. This may provide a higher level of security compared to a conventional ATM transaction that uses a payment card cryptogram plus a user's static PIN both received from the ATM. A static PIN entered at a public ATM may be relatively easy to steal, learn, or guess compared to user login credentials. For example, the user login credentials may be entered in a private location via a user computing device or a user mobile device prior to the user arriving at the public ATM. In addition, the user login credentials may include biometric information (e.g., a user's fingerprint) and/or a user name and password combination that may be required to periodically change.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a mobile computing device, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
receiving, by at least one server device of a bank network that includes an online banking system, user login credentials for a bank account of a user from a user computing device of the user via a login user interface of an online banking application for the online banking system, wherein the bank network includes the at least one server device, the online banking system, and at least one automated teller machine (ATM);
validating, by the at least one server device, the user login credentials against stored credentials for the user;
performing, by the at least one server device, a first factor of a two-factor authentication, wherein performing the first factor of the two-factor authentication includes authenticating access to the bank account by the user via the online banking application based on the validated user login credentials;
after authenticating access to the bank account by the user, receiving, by the at least one server device, transaction data for a pre-staged transaction from the user computing device of the user via the user interface of the online banking application for the online banking system;
associating, by the at least one server device, the pre-staged transaction stored by the at least one server device with the bank account including one or more payment cards of the user;
emitting, by a card reader of the at least one ATM, a signal within a range of a predetermined distance of the at least one ATM;
detecting, by the card reader of the at least one ATM, a mobile computing device within the predetermined distance from the at least one ATM;
receiving, by the at least one ATM and in response to the signal, a cryptogram of a payment card from the mobile computing device;
receiving, by the at least one server device, the cryptogram of the payment card from the at least one ATM;
performing, by the at least one server device, a second factor of the two-factor authentication, wherein performing the second factor of the two-factor authentication includes determining, based on identification information included in the cryptogram of the payment card, that the payment card at the at least one ATM is one of the one or more payment cards of the bank account associated with the pre-staged transaction;
authorizing, by the at least one server device based on the performance of the two-factor authentication, performance of the pre-staged transaction at the at least one ATM;
sending, by the at least one server device and to the at least one ATM, instructions for performance of the pre-staged transaction; and
performing, by the at least one ATM, the pre-staged transaction in response to receipt of the instructions from the at least one server device.

2. (canceled)

3. The method of claim 1, wherein the at least one server device comprises at least one bank server of the online banking system for a bank and one or more ATM servers of an ATM system in communication with a plurality of ATMs associated with the bank, wherein the bank network includes the ATM system, wherein the plurality of ATMs include the at least one ATM, and wherein the method further comprises:
after receiving the transaction data for the pre-staged transaction and associating the pre-staged transaction with the bank account, sending, by the at least one bank server, a list of pre-staged transactions, including the pre-staged transaction associated with the bank account, to the one or more ATM servers of the ATM system;
receiving, by the one or more ATM servers, the list of pre-staged transactions; and
wherein, after receiving the cryptogram of the payment card from the at least one ATM, determining that the payment card is associated with the pre-staged transaction comprises determining, by the one or more ATM servers, that the payment card is associated with the pre-staged transaction from the list of pre-staged transactions received from the at least one bank server.

4. The method of claim 1,
wherein associating the pre-staged transaction with the bank account comprises associating the pre-staged transaction with the bank account including the one or more payment cards for a period of time; and
wherein determining that the payment card at the at least one ATM is associated with the pre-staged transaction comprises determining that the cryptogram of the payment card is received by the at least one ATM during the period of time for the pre-staged transaction.

5. The method of claim 1, wherein associating the pre-staged transaction with the bank account comprises:
receiving, from the user computing device via the user interface of the online banking application, a selected payment card of the one or more payment cards of the bank account; and
associating the pre-staged transaction with the selected payment card for a period of time.

6. The method of claim 5, wherein determining that the payment card at the at least one ATM is associated with the pre-staged transaction comprises:
determining that the payment card is the selected payment card of the bank account associated with the pre-staged transaction; and
determining that the cryptogram of the selected payment card is received by the at least one ATM during the period of time for the pre-staged transaction.

7. The method of claim 1, wherein receiving the transaction data for the pre-staged transaction comprises:
receiving, from the user computing device via the user interface of the online banking application, input specifying a type of transaction and an amount of funds for the type of transaction; and
prior to associating the pre-staged transaction with the bank account, verifying, by the at least one server device, that the type of transaction can be performed using the bank account and that the bank account has an account balance that is sufficient to perform the type of transaction for the amount of funds.

8. The method of claim 1, wherein the pre-staged transaction at least in part comprises a cash withdrawal,
wherein authorizing performance of the pre-staged transaction at the at least one ATM further comprises withdrawing, by the at least one server device, an amount of funds for the cash withdrawal from the bank account;
wherein sending instructions for performance of the pre-staged transaction comprises sending, to the at least one ATM via the bank network, instructions for dispensing the amount of funds; and
wherein performing the pre-staged transaction comprises dispensing, by the at least one ATM, the amount of funds to the user via a cash dispenser of the at least one ATM.

9. The method of claim 1, wherein the online banking application comprises one of a mobile-based application executing on the user computing device or a web-based application accessible via a browser executing on the user computing device.

10. (canceled)

11. The method of claim 1, wherein the payment card comprises a virtual card including a wallet token as a tokenized version of the identification information accessible via a digital wallet application running on the mobile computing device, and wherein the cryptogram of the payment card comprises an authorization request cryptogram that includes the wallet token and is generated by the digital wallet application in response to the signal emitted by the card reader of the ATM.

12. The method of claim 1, wherein the cryptogram of the payment card comprises a first cryptogram of a first payment card, the method further comprising:
receiving, by the at least one server device, a second cryptogram of a second payment card from the at least one ATM;
wherein performing the second factor of the two-factor authentication includes determining, by the at least one server device and based on identification information included in the second cryptogram of the second payment card, that no pre-staged transaction is associated with the second payment card at the at least one ATM,
wherein sending instructions for performance of the pre-staged transaction comprises sending, by the at least one server device and to the at least one ATM via the bank network, instructions for presentation of a notification that no pre-staged transaction associated with the second payment card is found; and
presenting, by the at least one ATM, the notification via a display device of the at least one ATM.

13. The method of claim 1, wherein the pre-staged transaction comprises a first pre-staged transaction, and the cryptogram of the payment card comprises a first cryptogram of a first payment card, the method further comprising:
receiving, by the at least one server device, transaction data for a second pre-staged transaction;
associating, by the at least one server device, the second pre-staged transaction stored by the at least one server device with a second payment card for a period of time; and
receiving, by the at least one server device, a second cryptogram of the second payment card from the ATM;
wherein performing the second factor of the two-factor authentication includes determining, based on identification information included in the second cryptogram of the second payment card, that the second cryptogram of the second payment card is received by the at least one ATM after the period of time for the second pre-staged transaction associated with the second payment card has expired;
wherein sending instructions for performance of the pre-staged transaction at the at least one ATM comprises, in response to determining that the period of time for the second pre-staged transaction has expired, sending, by the at least one server device and to the at least one ATM via the bank network, instructions for presentation of a notification that no pre-staged transaction associated with the second payment card is found; and
presenting, by the at least one ATM, the notification via a display device of the at least one ATM.

14. A bank network system, wherein the bank network system comprises:
an online banking system;
at least one automated teller machine (ATM); and
at least one server device, the at least one server device comprising:
one or more programmable processors;
a memory storing instructions that, when executed by the one or more programmable processors, cause the one or more programmable processors to perform the steps of:
receiving user login credentials for bank account of a user from a user computing device of the user via a login user interface of an online banking application for the online banking system;
validating the user login credentials against stored credentials for the user;
performing a first factor of a two-factor authentication, wherein
performing the first factor of the two-factor authentication includes authenticating access to the bank account by the user via the online banking application based on the validated user login credentials;
after authenticating access to the bank account by the user, receiving transaction data for a pre-staged transaction from the user computing device of the user via the user interface of the online banking application for the online banking system;
associating the pre-staged transaction stored by the at least one server device with the bank account including one or more payment cards of the user;
receiving a cryptogram of a payment card from the at least one ATM;
performing a second factor of the two-factor authentication, wherein
performing the second factor of the two-factor authentication includes determining, based on identification information included in the cryptogram of the payment card, that the payment card at the at least one ATM is one of the one or more payment cards of the bank account associated with the pre-staged transaction;
authorizing, based on the performance of the two-factor authentication,
performance of the pre-staged transaction at the at least one ATM; and
sending, to the least one ATM, instructions for performance of the pre-staged transaction, and
wherein the at least one ATM:
emits, by a card reader of the at least one ATM, a signal within a range of a predetermined distance of the at least one ATM;
detects, by the card reader of the at least one ATM, a mobile computing device within the predetermined distance from the at least one ATM;
receives, in response to the signal, the cryptogram of the payment card from the mobile computing device; and
performs the pre-staged transaction in response to receipt of the instructions from the at least one server device.

15. (canceled)

16. The system of claim 14, wherein the bank network system comprises:
one or more ATM servers of an ATM system in communication with a plurality of ATMs associated with a bank, wherein the plurality of ATMs include the at least one ATM; and
at least one bank server of the online banking system for the bank, wherein the instructions cause at least one programmable processor of the at least one bank server to perform the steps of:
receiving the transaction data for the pre-staged transaction,
associating the pre-staged transaction with the bank account, and
sending a list of pre-staged transactions, including the pre-staged transaction associated with the bank account, to the one or more ATM servers of the ATM system,
wherein the one or more ATM servers are configured to perform the steps of:
receiving the list of pre-staged transactions from the at least one bank server,
receiving the cryptogram of the payment card from the at least one ATM,
determining that the payment card is associated with the pre-staged transaction from the list of pre-staged transactions, and
authorizing performance of the pre-staged transaction at the at least one ATM.

17. The system of claim 14,
wherein to associate the pre-staged transaction with the bank account, the instructions further cause the one or more programmable processors to perform the step of associating the pre-staged transaction with the bank account including the one or more payment cards for a period of time; and
wherein to determine that the payment card at the at least one ATM is associated with the pre-staged transaction, the instructions further cause the one or more programmable processors to perform the step of determining that the cryptogram of the payment card is received by the at least one ATM during the period of time for the pre-staged transaction.

18. The system of claim 14, wherein to associate the pre-staged transaction with the bank account, the instructions further cause the one or more programmable processors to perform the steps of:
receiving, from the user computing device via the user interface of the online banking application, a selected payment card of the one or more payment cards of the bank account; and
associating the pre-staged transaction with the selected payment card for a period of time.

19. The system of claim 18, wherein to determine that the payment card at the at least one ATM is associated with the pre-staged transaction, the instructions further cause the one or more programmable processors to perform the steps of:
determining that the payment card is the selected payment card of the bank account associated with the pre-staged transaction; and
determining that the cryptogram of the selected payment card is received by the at least one ATM during the period of time for the pre-staged transaction.

20. A non-transitory computer-readable medium storing instructions that, when executed by one or more programmable processors of a bank network that includes the at least one server device, an online banking system, and at least one automated teller machine (ATM), cause the one or more programmable processors to perform the steps of:
receiving, by the at least one server device, user login credentials for a bank account of a user from a user computing device of the user via a login user interface of an online banking application for the online banking system;
validating, by the at least one server device, the user login credentials against stored credentials for the user;
performing, by the at least one server device, a first factor of a two-factor authentication, wherein performing the first factor of the two-factor authentication includes authenticating access to the bank account by the user via the online banking application based on the validated user login credentials;
after authenticating access to the bank account by the user, receiving, by the at least one server device, transaction data for a pre-staged transaction from the user computing device of the user via the user interface of the online banking application for the online banking system;
associating, by the at least one server device, the pre-staged transaction stored by the at least one server device with the bank account including one or more payment cards of the user;
emitting, by a card reader of the at least one ATM, a signal within a range of a predetermined distance of the at least one ATM;
detecting, by the card reader of the at least one ATM, a mobile computing device within the predetermined distance from the at least one ATM;
receiving, by the at least one ATM and in response to the signal, a cryptogram of a payment card from the mobile computing device;
receiving, by the at least one server device, the cryptogram of the payment card from the at least one ATM;
performing, by the at least one server device, a second factor of the two-factor authentication, wherein performing the second factor of the two-factor authentication includes determining, based on identification information included in the cryptogram of the payment card, that the payment card at the at least one ATM is the one of the one or more payment cards of the bank account associated with the pre-staged transaction;
authorizing, by the at least one server device based on the performance of the two factor authentication, performance of the pre-staged transaction at the at least one ATM;
sending, by the at least one server device to the at least one ATM, instructions for performance of the pre-staged transaction; and
performing, by the at least one ATM, the pre-staged transaction in response to receipt of the instructions from the at least one server device.
